(19) United States
(12) Patent Application Publication
(10) Pub. No.: US 2012/0253729 A1
(43) Pub. Date: Oct. 4, 2012

(54) Test system, test signal auxiliary device, and test signal generation method thereof

(75) Inventors: Wen-Hui Shih, Taipei Hsien (TW); Chia-Yuan Wang, Taipei Hsien (TW); Huan-Chieh Hu, Taipei Hsien (TW); Ting-Wen Liu, Taipei Hsien (TW)

(73) Assignee: Wistron Corporation, Taipei Hsien (TW)

(21) Appl. No.: 13/067,976

(22) Filed: Jul. 13, 2011

(30) Foreign Application Priority Data
Mar. 30, 2011 (TW) 100111083

(51) Int. Cl. G06F 19/00

(52) U.S. Cl. 702/116

(57) ABSTRACT

A test system, a test signal auxiliary device, and a test signal generation method thereof are disclosed. The test signal auxiliary device is used for providing a computer system to test a signal measurement device. The test signal auxiliary device includes a first signal input terminal used for receiving an analog test signal via a first audio port of the computer system. A filter module is used for filtering the analog test signal to produce a filtered signal. A first signal output terminal is used for outputting the filtered signal to the signal measurement device. A second signal input terminal is used for receiving a corresponding signal from the signal measurement device. A second signal output terminal is used for transmitting the corresponding signal to the computer system via a second audio port.

### BACKGROUND OF THE INVENTION

1. Field of the Invention

The present invention relates to a test system, a test signal auxiliary device, and a test signal generation method thereof; more particularly, the present invention relates to a test system, a test signal auxiliary device, and a test signal generation method thereof capable of generating an analog signal by an audio port.

2. Description of the Related Art

As technology advances, modern medical test devices, like an electrocardiograph machine or an electroencephalography machine, are frequently used in daily life. These medical test devices are capable of capturing a micro electrical signal from the body and amplifying the signal to execute a further process or determine whether the physiological signal is normal.

In order to determine whether medical test devices are normal, a specific test instrument used for testing the medical test device is disclosed in the prior art. The test instrument comprises software and hardware. The software can be LabVIEW, produced by National Instruments®, and is capable of setting a frequency or an amplitude of a simulated signal that is used for testing the medical test device. The hardware can be a dynamic signal analyzer PXI-4461, produced by National Instruments®, and is capable of generating the simulated signal to the medical test device and receiving a corresponding signal from the medical test device. Finally, the software of the test instrument determines whether the corresponding signal from the medical test device is normal or not. However, if a user tests the medical test device by using the test instrument aforementioned, the user has to be familiar with the operation of the software of the test instrument. In addition, the testing processing aforementioned is very complicated and the test instrument is not cost effective. Therefore, it causes inconvenience to the user.

Therefore, there is a need to provide a novel test system, a test auxiliary device, and a test signal generation method to mitigate and/or obviate the aforementioned problems

### SUMMARY OF THE INVENTION

It is an object of the present invention to provide a test signal auxiliary device capable of transmitting an analog test signal via an audio port.

It is another object of the present invention to provide a test signal generation method for the aforementioned test signal auxiliary device.

It is another object of the present invention to provide a test system having the aforementioned test signal auxiliary device.

To achieve the aforementioned objects, a test signal auxiliary device of the present invention is used with a computer system to test a signal measurement device. The test signal auxiliary device comprises a first signal input terminal, a filter module, a first signal output terminal, a second signal input terminal, and a second signal output terminal. The first signal input terminal is electrically connected to a first audio port to receive an analog test signal. The filter module is electrically connected to the first signal input terminal and used for filtering the analog test signal to produce a filtered signal. The first signal output terminal is electrically connected to the filter module and the signal measurement device and used for outputting the filtered signal to the signal measurement device. The second signal input terminal is electrically connected to the signal measurement device and used for receiving a corresponding signal from the signal measurement device. The second signal output terminal is electrically connected to a second audio port of the computer system and is used for transmitting the corresponding signal to the computer system.

A test signal generation method of the present invention comprises the following steps: outputting an analog test signal from a first audio port of the computer system; filtering the analog test signal to produce a filtered signal; outputting the filtered signal to the signal measurement device; receiving a corresponding signal from the signal measurement device; and transmitting the corresponding signal via a second audio port to the computer system.

A test system of the present invention is used to test a signal measurement device. The test system comprises a computer system and a test signal auxiliary device. The computer system comprises a processing module, a first audio port, and a second audio port. The processing module is used for generating an analog test signal. The first audio port is electrically connected to the processing module to transmit the analog test signal. The second audio port is electrically connected to the processing module. The test signal auxiliary device comprises a first signal input terminal, a first signal output terminal, a second signal input terminal, a second signal input terminal, and a second signal output terminal. The first signal input terminal is electrically connected to the first audio port to receive the analog test signal. The filter module is electrically connected to the first signal input terminal and used for filtering the analog test signal to produce a filtered signal. The first signal output terminal is electrically connected to the filter module and the signal measurement device and used for outputting the filtered signal to the signal measurement device. The second signal input terminal is electrically connected to the signal measurement device and used for receiving a corresponding signal from the signal measurement device. The second signal output terminal is electrically connected to a second audio port of the computer system and used for transmitting the corresponding signal to the computer system.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a schematic of a test system according to a first embodiment of the present invention.

FIG. 2 illustrates a schematic of a test system according to a second embodiment of the present invention.

FIG. 3 illustrates a flowchart of a test signal transmitting method according to the present invention.

### DETAILED DESCRIPTION OF THE PREFERRED EMBODIMENT

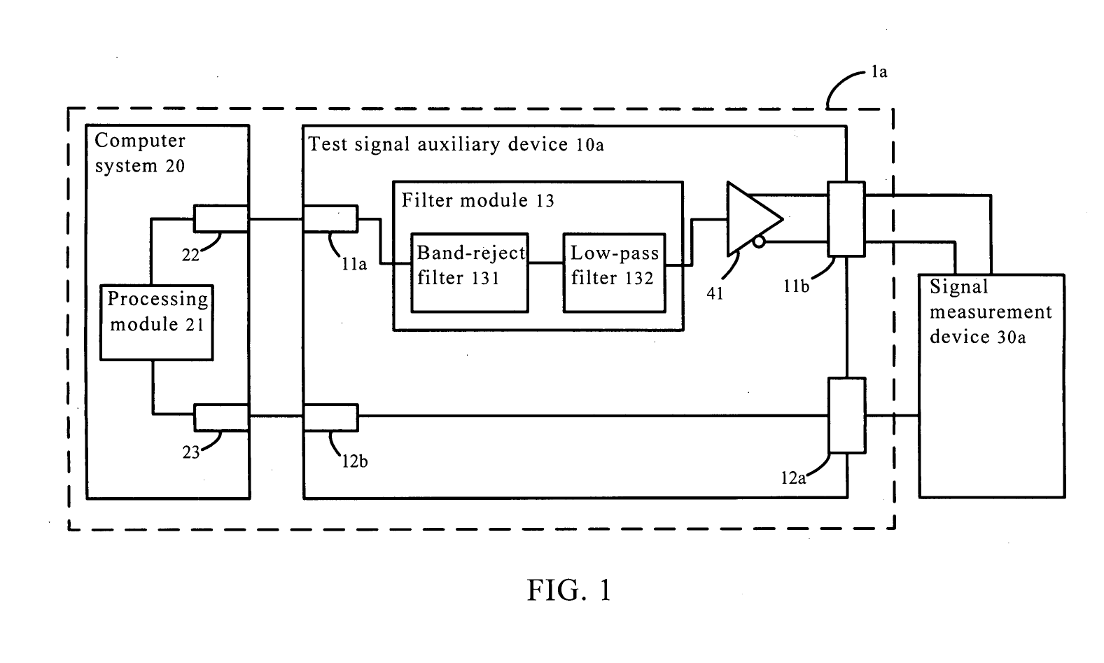

Please refer to FIG. 1, which illustrates a schematic of a test system according to first embodiment of the present invention.

The test system 1a of the first embodiment of the present invention comprises a test signal auxiliary device 10a and a computer system 20 and is used for testing a signal measurement device 30a. The test signal auxiliary device 10a is electrically connected to the computer system 20 such that the computer system 20 can transmit an analog test signal to the signal measurement device 30a to determine whether the function of the signal measurement device 30a is normal. The signal measurement device 30a can be a device under test (DUT), such as an electrocardiograph machine or an electroencephalography machine. However, please note that the signal measurement device 30a of the present invention is not limited to the above description.

The computer system 20 comprises a processing module 21, a first audio port 22, and a second audio port 23. The processing module 21 can be a chip or architecture constructed by software with hardware and is used for generating an analog test signal. In one embodiment of the present invention, the analog test signal is a sine waveform signal. However, please note that the present invention is not limited to the above description. The analog test signal can also be a simulated electrocardiogram signal. The first audio port 22 is an audio output jack and used for outputting an analog signal. The first audio port 22 is electrically connected to the processing module 21 and transmits the analog test signal generated from the processing module 21 to the test signal auxiliary device 10a. The second audio port 23 is an audio input jack and used for inputting an analog signal. The second audio port 23 is electrically connected to the processing module 21 and used for transmitting a corresponding signal generated by the test signal auxiliary device 10a to the processing module 21, and allows the processing module 21 to execute further comparison. The method of comparing the corresponding signals of the computer system 20 will be described later; therefore, it will not be further described at this time.

In a first embodiment of the present invention, the test signal auxiliary device 10a comprises a first signal input terminal 11a, a first signal output terminal 11b, a second signal input terminal 12a, a second signal output terminal 12b, a filter module 13, and a differentiator 41.

The first signal input terminal 11a is electrically connected to the first audio port 22 of the computer system 20 to receive the analog test signal, wherein the first signal input terminal 11a and the first audio port 22 of the computer system 20 can have the same specifications and electrically connect to each other via an audio line. However, please note that the present invention is not limited to the above description.

The filter module 13 is electrically connected to the first signal input terminal 11a and used for filtering the analog test signal to a filtered signal. The filter module 13 comprises a band-reject filter (e.g., a Notch Filter) 131 and a low-pass filter 132. Because the power source of the computer system 20 is the mains supply, in order to avoid the interference of the noise of the mains supply, the test signal auxiliary device 10a is used for blocking signals matching the frequency of the mains supply with the band-reject filter 131. In the present embodiment, the band-reject filter 131 is used for blocking a 60 Hz signal. The low-pass filter 132 is used for blocking a high frequency signal that cannot be a physiological signal. In the present embodiment, the low-pass filter 132 is used for blocking a signal over 200 Hz. Because the band-reject filter 131 and the low-pass filter 132 are well-known apparatuses, the details of the band-reject filter 131 and the low-pass filter 132 are not explained herein.

The first signal output terminal 11b is electrically connected to the filter module 13 and the signal measurement device 30a and used for outputting the filtered signal to the signal measurement device 30a. Please note that in order to reduce the noise detected, the signal measurement device 30a is capable of receiving a positive signal and an inverse signal at the same time. As a result, the signal measurement device 30a in the present embodiment has two input ports. Moreover, the test signal auxiliary device 10a further comprises a differentiator 41. The differentiator 41 is electrically connected between the filter module 13 and the first signal output terminal 11b and used for separating the filtered signal into a positive filtered signal and an inverse filtered signal. Then the differentiator 41 transmits the positive filtered signal and the inverse filtered signal to the signal measurement device 30a via the first signal output terminal 11b. Because the differentiator 41 is a well-known apparatus, and because the details of the differentiator 41 are not within the field of the subject matter of the present invention, the details of the differentiator 41 are not explained herein.

After receiving the filtered signal, the signal measurement device 30a transforms the filtered signal into the corresponding signal. Then the corresponding signal is transmitted back to the test signal auxiliary device 10a, wherein the amplitude of the corresponding signal is larger than amplitude of the original analog test signal. The processing of the signal measurement device 30a is known in the art and will not be further described. The second signal input terminal 12a of the test signal auxiliary device 10a is electrically connected to the signal measurement device 30a and used for receiving the corresponding signal from the signal measurement device 30a.

The second signal output terminal 12b is electrically connected to the second signal input terminal 12a and the second audio port 23 of the computer system 20 and used for transmitting the corresponding signal to the computer system 20. Similarly, the second signal output terminal 12b and the second audio port 23 of the computer system can have the same specifications and electrically connect to each other via an audio line. It is noted that the present invention is not limited to the structure of the second signal output terminal 12b and the second audio port 23.

Finally, the processing module 21 of the computer system 20 further determines whether the corresponding signal is a normal magnified signal of the analog test signal or a distorted signal. For example, if the signal measurement device 30a is capable of magnifying the original signal ten times, then when an analog test signal with 100 Hz frequency and 100 mv amplitude is inputted, the signal measurement device 30a should generate a corresponding signal with 100 Hz frequency and 1000 mv amplitude. Therefore, the processing module 21 of the computer system 20 determines whether the signal measurement device 30a has output the corresponding signal with the correct frequency and amplitude, or compares the waveform of the corresponding signal with the waveform of the analog test signal to determine whether the waveform of the corresponding signal is distorted.

The processing module 21 of the computer system 20 is capable of transforming a time domain into a frequency domain by using a Fast Fourier Transform (FFT) algorithm. Then the processing module 21 determines whether the frequency and the amplitude of the corresponding signal are normal. The method of transformation using the FFT algorithm is known in the art and will not be further described. It is noted that the present invention is not only limited to the computer system 20 executing the transformation process using the FFT algorithm.

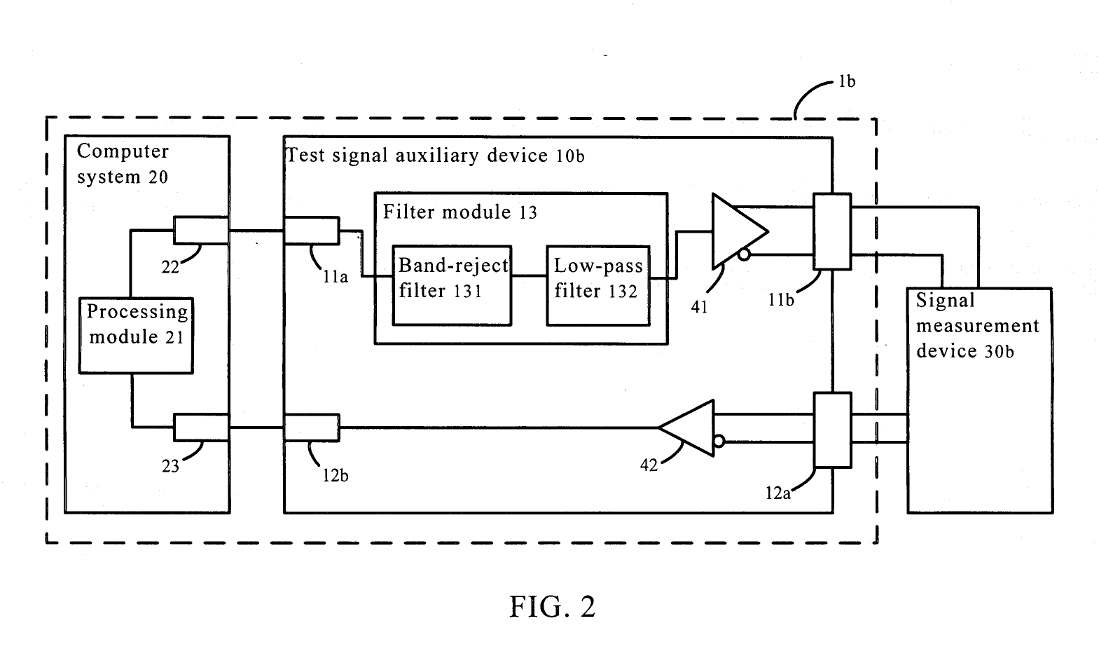

Please refer to FIG. 2, which presents a schematic of a test system according to second embodiment of the present invention.

In a second embodiment of the present invention, the signal measurement device 30b outputs a positive signal and an inverse signal at the same time. In order to match the specifications of the signal measurement device 30b, the test signal auxiliary device 10b of the test system 1b further comprises an operational amplifier 42. The operational amplifier 42 is electrically connected to the second signal input terminal 12a and used for integrating the positive corresponding signal and the inverse corresponding signal into a single corresponding signal. Then the corresponding signal is outputted to the computer system 20 via the second signal output terminal 12b and a further process is executed. The circuit of the operational amplifier 42 is known in the art and will not be further described.

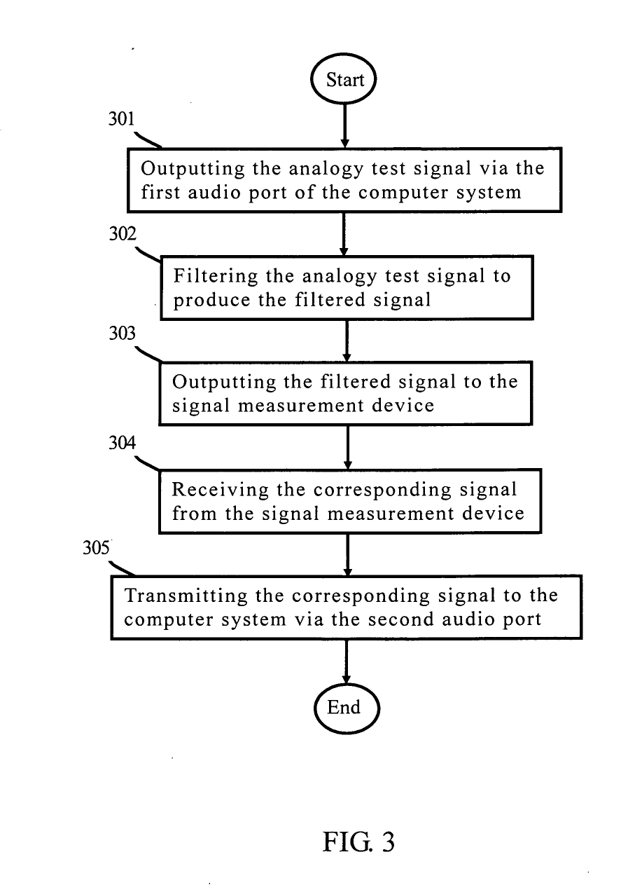

Please refer to FIG. 3, which presents a flowchart of a test signal transmitting method according to the present invention. It is noted that although the test signal transmitting method is used here for the test signal auxiliary device 10a in this embodiment, the test signal transmitting method can be applied in devices other than the test signal auxiliary device 10a.

The method starts at step 301: outputting the analog test signal via the first audio port of the computer system.

First, the processing module 21 of the computer system 20 generates the analog test signal. Then the analog test signal is outputted to the test signal auxiliary device 10a via the first audio port 22 of the computer system 20.

Then the method proceeds to step 302: filtering the analog test signal to produce the filtered signal.

Then the filter module 13 filters the analog test signal to produce the filtered signal. In one embodiment of the present invention, the filter module 13 blocks the noise from the mains supply with the band-reject filter 131 and blocks unnecessary high frequencies with the low-pass filter 132.

Then the method proceeds to step 303: outputting the filtered signal to the signal measurement device.

Then the filtered signal is outputted to the signal measurement device 30a via the first signal output terminal 11b. In one embodiment of the present invention, the differentiator 41 is used for separating the filtered signal into a positive signal and an inverse signal based on the specifications of the signal measurement device 30a and is also used for transmitting the positive and inverse signals to the signal measurement device 30a.

Then the method proceeds to step 304: receiving the corresponding signal from the signal measurement device.

After the signal measurement device 30a receives the filtered signal, the corresponding signal is outputted. For example, the corresponding signal can be a filtered signal with amplitude magnification. Therefore, the second signal input terminal 12a receives the corresponding signal from the signal measurement device 30a. On the other hand, the signal measurement device 30a can also output the positive and the inverse corresponding signals. Therefore, in one embodiment of the present invention, the second signal input terminal 12a is capable of integrating the positive and the inverse corresponding signals in a single corresponding signal with the operational amplifier 42.

Finally, the method proceeds to processing step 305: transmitting the corresponding signal to the computer system via the second audio port.

Finally, the test signal auxiliary device 10a transmits the corresponding signal from the second signal output terminal 12b to the computer system 20 via the second audio port 23. Then the processing module 21 of the computer system 20 determines whether the corresponding signal corresponds to the analog test signal. If the corresponding signal corresponds to the analog test signal, then the signal measurement device 30a is normal.

It is noted that the present invention is not limited to the order of the steps of the test signal transmitting method; the order of the steps of the test signal transmitting method can be changed as long as the object is achieved.

As a result, a user using the test system 1a and test signal generation method aforementioned can test the signal measurement device 30a conveniently and cost of such a test can be reduced.

Although the present invention has been explained in relation to its preferred embodiments, it is to be understood that many other possible modifications and variations can be made without departing from the spirit and scope of the invention as hereinafter claimed.

What is claimed is:

1. A test signal auxiliary device used with a computer system to test a signal measurement device, the test signal auxiliary device comprising:
a first signal input terminal, electrically connected to a first audio port to receive an analog test signal;
a filter module, electrically connected to the first signal input terminal and used for filtering the analog test signal to produce a filtered signal;
a first signal output terminal, electrically connected to the filter module and the signal measurement device and used for outputting the filtered signal to the signal measurement device;
a second signal input terminal, electrically connected to the signal measurement device and used for receiving a corresponding signal from the signal measurement device; and
a second signal output terminal, electrically connected to a second audio port of the computer system and used for transmitting the corresponding signal to the computer system.

2. The test signal auxiliary device as claimed in claim 1, wherein the filter module comprises a band-reject filter used for blocking a 60 Hz signal.

3. The test signal auxiliary device as claimed in claim 2, wherein the filter module comprises a low-pass filter used for blocking a signal over 200 Hz.

4. The test signal auxiliary device as claimed in claim 1, further comprising a differentiator electrically connected between the filter module and the first signal output terminal.

5. The test signal auxiliary device as claimed in claim 1, further comprising an operational amplifier electrically connected to the second signal input terminal.

6. A test signal generation method used with a computer system to test a signal measurement device via a test signal auxiliary device, the method comprising the following steps:
outputting an analog test signal from a first audio port of the computer system;
filtering the analog test signal to produce a filtered signal;
outputting the filtered signal to the signal measurement device;
receiving a corresponding signal from the signal measurement device; and
transmitting the corresponding signal via a second audio port to the computer system.

7. The test signal generation method as claimed in claim 6, further comprising:
blocking a 60 Hz signal.

8. The test signal generation method as claimed in claim 7, further comprising:
blocking a signal over 200 Hz.

9. A test system used to test a signal measurement device comprising:
a computer system, comprising:
a processing module, used for generating an analog test signal;
a first audio port, electrically connected to the processing module to transmit the analog test signal; and
a second audio port, electrically connected to the processing module; and
a test signal auxiliary device, comprising:
a first signal input terminal, electrically connected to the first audio port to receive the analog test signal;
a filter module, electrically connected to the first signal input terminal and used for filtering the analog test signal to produce a filtered signal;
a first signal output terminal, electrically connected to the filter module and the signal measurement device and used for outputting the filtered signal to the signal measurement device;
a second signal input terminal, electrically connected to the signal measurement device and used for receiving a corresponding signal from the signal measurement device; and
a second signal output terminal, electrically connected to a second audio port of the computer system and used for transmitting the corresponding signal to the computer system.

10. The test system as claimed in claim 9, wherein the filter module comprises a band-reject filter used for blocking a 60 Hz signal.

11. The test system as claimed in claim 10, wherein the filter module comprises a low-pass filter used for blocking a signal over 200 Hz.

12. The test system as claimed in claim 9, wherein the processing module further compares the analog test signal and the corresponding signal based on a Fast Fourier Transform (FFT) algorithm.

13. The test system as claimed in claim 9, wherein the test signal auxiliary device further comprises a differentiator electrically connected between the filter module and the first signal output terminal.

14. The test system as claimed in claim 9, wherein the test signal auxiliary device further comprises an operational amplifier electrically connected to the second signal input terminal.
